(19) United States
(12) Patent Application Publication
(10) Pub. No.: US 2006/0262533 A1
(43) Pub. Date: Nov. 23, 2006

(54) Modular light emitting diode

(75) Inventors: Huei-Tso Lin, Lucao Town (TW); Ching-Yuan Lin, Lucao Town (TW)

Correspondence Address: TROXELL LAW OFFICE PLLC, SUITE 1404, 5205 LEESBURGH PIKE, FALLS CHURCH, VA, 22041, US

(73) Assignee: Para Light Electronics Co., Ltd.

(21) Appl. No.: 11/131,373

(22) Filed: May 18, 2005

(51) Int. Cl. F21V 21/00

(52) U.S. Cl. 362/249; 362/294

(57) ABSTRACT

A modular light emitting diode is disclosed. The modular light emitting diode comprises a heat-sinking base, a circuit board, a LED light emitting device, and a waterproofing layer. A protrudent portion and a plurality of trenches are formed on the surface of the heat-sinking base. Waterproof connection terminals are mounted on both sides of the circuit board. The LED light emitting device is mounted on and connected to the circuit board so as to form a complete circuit. Thereafter, the circuit board on which the LED light emitting device is mounted is stacked on the heat-sinking base to allow the LED light emitting device to be mounted on the protrudent portion of the heat-sinking base. These three stacked components are locally packaged by a waterproofing layer to complete the modular light emitting diode having the advantages of good waterproofing, rapid heat sinking, and flexible assembly.

### FIELD OF THE INVENTION

The present invention relates to a modular light emitting diode having the advantages of good waterproofing, rapid heat sinking, and flexible assembly for being suitable for a photoelectric package, for example, a light emitting diode or the like.

### BACKGROUND OF THE INVENTION

Because of having low power consumption and long lifetime, the light emitting diode is widely applied to various light emitting structures such as traffic lights, emergency illumination, emergency signs, etc. The conventional light emitting diode is shown in FIG. 5. A chip B is mounted in a notched cup A1 (optical cavity) of a first frame A, and connected to a second frame D via a metal wire C. The top ends of the first frame A and the second frame D, the chip B, and the metal wire C are packaged by a transparent layer E to complete the manufacture of the light emitting diode.

The required amount of light emitting diodes must be welded to the circuit board first before use. Generally speaking, however, the luminosity efficiency and the interface temperature of the light emitting diode are in inverse proportion. Therefore, keeping the die temperature lower than the interface temperature is the principally concerned subject regarding the LED package. Accordingly, the packaged chip is easily damaged by the heat stress. Moreover, the major deficiency of the conventional structure consists in that it is very complicated to detach the damaged light emitting diode from the circuit board to replace it with a new one when the light emitting diode is damaged. Consequently, a lot of time and manpower are wasted.

In view of the description mentioned above, the present inventor makes diligent studies with a quiet mind in designing and manufacturing a modular light emitting diode having the advantages of good waterproofing, rapid heat sinking, and flexible assembly.

### SUMMARY OF THE INVENTION

It is a main object of the present invention to provide a modular light emitting diode having the advantages of good waterproofing, rapid heat sinking, and flexible assembly.

In order to achieve the aforementioned object, a modular light emitting diode is disclosed. The modular light emitting diode comprises a heat-sinking base, a circuit board, a LED light emitting device, and a waterproofing layer. A protrudent portion and a plurality of trenches are formed on the surface of the heat-sinking base. Waterproof connection terminals are mounted on both sides of the circuit board. The LED light emitting device is mounted on and connected to the circuit board so as to form a complete circuit. Thereafter, the circuit board on which the LED light emitting device is mounted is stacked on the heat-sinking base to allow the LED light emitting device to be mounted on the protrudent portion of the heat-sinking base. These three stacked components are locally packaged by a waterproofing layer to complete the modular light emitting diode having the advantages of good waterproofing, rapid heat sinking, and flexible assembly.

The aforementioned objects and advantages of the present invention will be readily clarified in the description of the preferred embodiments and the enclosed drawings of the present invention.

### BRIEF DESCRIPTION OF THE DRAWINGS

FIG. 1 is an elevational view showing a preferred embodiment of the present invention.

FIG. 2 is an exploded view showing the preferred embodiment of the present invention.

FIG. 3 is a schematic view showing that the modular light emitting diodes of the present invention are connected with one another.

FIG. 4 is another schematic view showing that the modular light emitting diodes of the present invention are connected with one another.

FIG. 5 is a cross-sectional view showing the conventional light emitting diode.

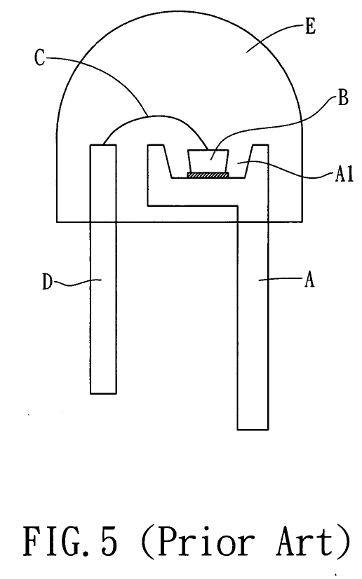

### DETAILED DESCRIPTION OF THE PREFERRED EMBODIMENT

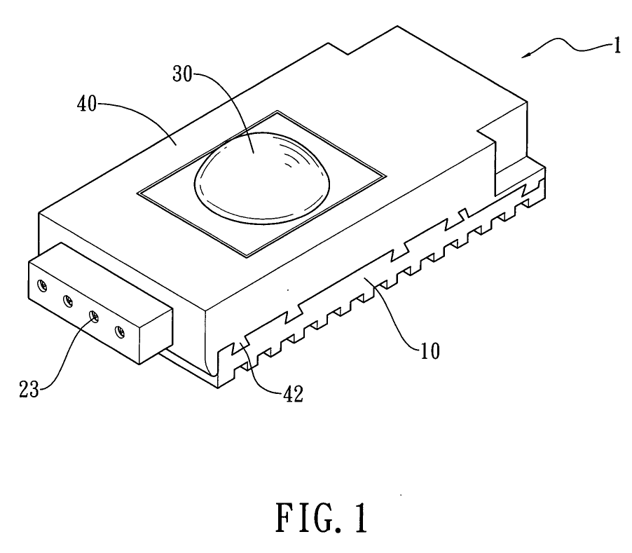

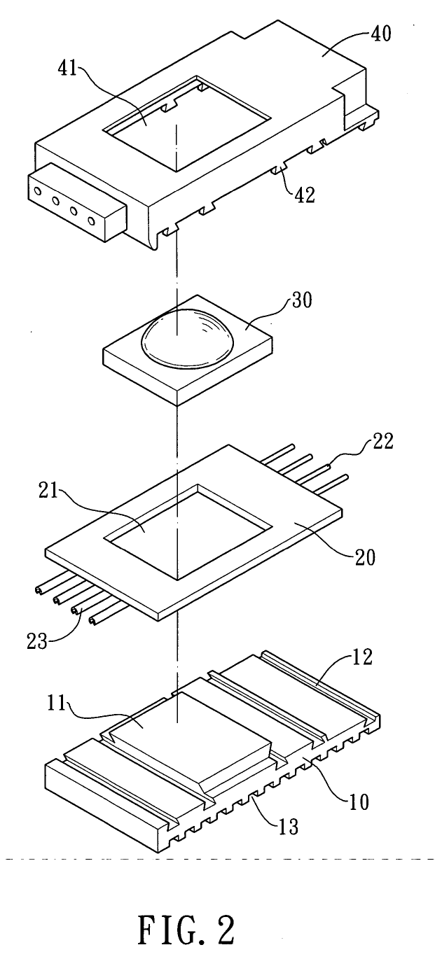

Referring to FIG. 1 and FIG. 2, a modular light emitting diode 1 of the present invention comprises: a heat-sinking base 10, an circuit board 20, a LED light emitting device 30, and a waterproofing layer 40, wherein a large-area protrudent portion 11 and several trenches 12 are formed on the surface of the heat-sinking base 10. Besides, several trenches 13 are formed on the bottom surface of the heat-sinking base 10 to increase the surface area for heat sinking.

A hole 21 is formed on the circuit board 20 corresponding to the protrudent portion 11 of the heat-sinking base 10, and different circuits may be designed to be formed on the circuit board 20 in accordance with different needs. Besides, waterproof (male and female) connection terminals 22, 23 are mounted on the opposite sides of the circuit board 20. Moreover, the connection terminals 22, 23 are inwardly extended into the hole 21 to form at least two contacts (not shown) around the hole 21.

The LED light emitting device 30 is mounted in a position corresponding to the hole 21 of the circuit board 20. Besides, at least a chip, a first electrode having a notched cup for holding the chip, a second electrode having an amount corresponding to that of the chip, a metal wire for connecting the chip and the second electrode, and a transparent layer for locally packaging the top ends of the first and second electrodes are mounted inside the LED light emitting device 30.

The LED light emitting device 30 is mounted in the hole 21 of the circuit board 20 to connect the electrodes of the LED light emitting device 30 with the contacts of the circuit board 20, thereby forming a complete circuit. The above-mentioned circuit board 20 on which the LED light emitting device 30 is mounted is stacked on the heat-sinking base 10 for allowing the LED light emitting device 30 to contact with the protrudent portion 11 of the heat-sinking base 10 directly. After that, a waterproofing layer 40 is then formed by an injection molding machine to locally cover these three above-mentioned stacked components. The waterproofing layer 40 has a hole 41 corresponding to the LED light emitting device 30 to prevent the transparent layer of the LED light emitting device 30 from being covered by the waterproofing layer 40. Furthermore, several protrudent locking bars 42, which are mounted on the bottom surface of the waterproofing layer 40, are inserted into the trenches 12 of the heat-sinking base 10 for increasing the tightness among the components, thereby forming the modular light emitting diode 1.

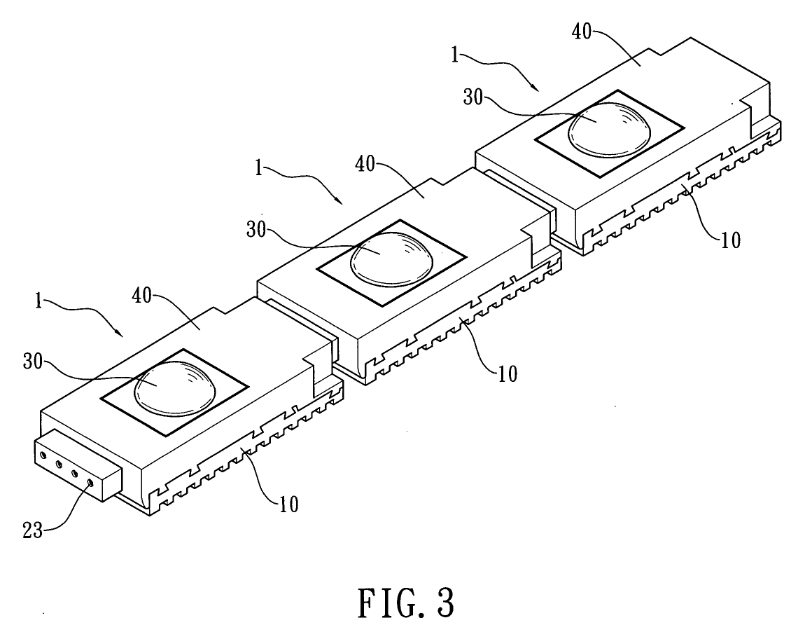

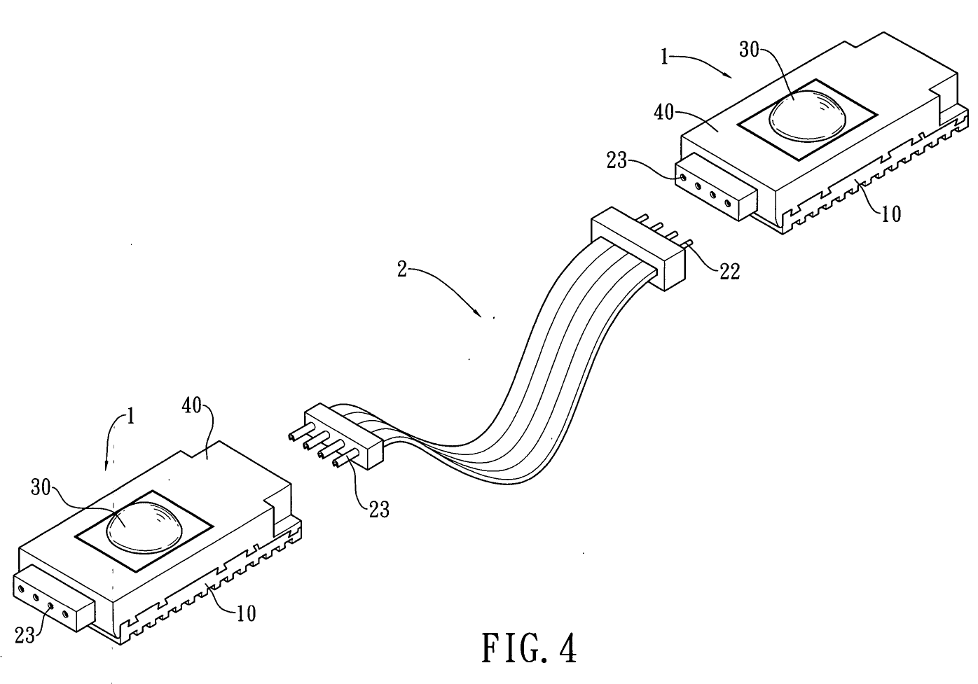

As shown in FIG. 3, the modular light emitting diodes 1 can be connected to one another by use of the connection terminals 22, 23, which are mounted at the ends, to form a successive light emitting strip. Alternatively, as shown in FIG. 4, two modular light emitting diodes 1 can be mutually connected by a connection cable 2 on two ends of which (male and female) connection terminals 22, 23 are respectively mounted for spacing these two modular light emitting diodes 1 at a proper distance. Furthermore, the heat, which is generated by the working of the LED light emitting device 30, is delivered to the heat-sinking base 10 through the protrudent portion 11 that contacts with the LED light emitting device 30. Besides, this heat can be rapidly dispersed by these trenches 13 to reduce the probability of the LED light emitting device 30 being damaged.

If one of the modular light emitting diodes 1 is failed, then only the connection terminals 22, 23 of this damaged modular light emitting diode 1 are in need of being detached from other connection terminals 22, 23 so as to replace this damaged modular light emitting diode 1 with a new one. Accordingly, it is very convenient, and the repairing process and the repairing time are simplified efficiently.

On the basis of the above-mentioned description, the structure of the present invention comprises the following practical advantages, in which:

1. When LED light emitting device is stacked on the heat-sinking base, the heat generated by the LED light emitting device in working can be dispersed rapidly by the heat-sinking base so as to reduce the probability of the LED light emitting device being damaged.

2. By use of the modular design, the present invention provides the advantages of good waterproofing, rapid heat sinking, and flexible assembly. Besides, the follow-up maintenance and replacement can be performed easily and conveniently.

On the basis of the aforementioned description, it is apparent that the present invention can achieve the expected purposes. The present invention satisfies all requirements for a patent and is submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A modular light emitting diode, comprising:
a heat-sinking base having a protrudent portion and a plurality of first trenches on a top surface thereof;
a circuit board having a hole formed thereon and a plurality of connection terminals oppositely mounted on the circuit board to be extended inwardly into the hole for forming a plurality of contacts around the hole;
a LED light emitting device mounted in the hole of the circuit board; and
an injection-molded waterproofing layer, in which the circuit board on which the LED light emitting device is mounted is stacked on the heat-sinking base to allow the LED light emitting device to contact with the protrudent portion of the heat-sinking base directly, and the stacked heat-sinking base, circuit base, and LED light emitting device are locally packaged by the waterproofing layer to complete the modular light emitting diode.

2. The modular light emitting diode of claim 1, wherein the LED light emitting device further comprises: at least a chip; a first electrode having a notched cup for holding the chip; a second electrode having an amount corresponding to that of the chip; a metal wire for connecting the chip and the second electrode; and a transparent layer for locally packaging the top ends of the first and second electrodes.

3. The modular light emitting diode of claim 1, further comprising a plurality of second trenches formed on the bottom of the heat-sinking base for increasing a surface area for heat sinking.

4. The modular light emitting diode of claim 1, wherein the waterproofing layer is made of polymer material or a mixture of polymer material and ceramic powder, and formed by injection molding.

5. The modular light emitting diode of claim 1, wherein the connection terminals oppositely mounted on the circuit board are waterproof.
